(19) United States
(12) Patent Application Publication
(10) Pub. No.: US 2004/0146607 A1
(43) Pub. Date: Jul. 29, 2004

(54) Method of preparing bioenergetic nourishing water

(76) Inventor: Chia-Sheng Chen, Taichung (TW)

Correspondence Address: Chia-Sheng Chen, 58, MA YUAN WEST ST., TAICHUNG, TW

(21) Appl. No.: 10/356,760

(22) Filed: Jan. 29, 2003

(51) Int. Cl. A23L 2/00

(52) U.S. Cl. 426/66

(57) ABSTRACT

A method of preparing bioenergetic nourishing water has steps of filtrating water from a water source to form a filtrated water, adjusting a hardness of the filtrated water, filtrating the filtrated water with ceramics to remove an original memory structure of the filtrated water, adding main herb liquid into the filtrated water to form a mixture, magnetizing the mixture to remove the main herb liquid from the mixture and to input and to arrange a new memory structure of the mixture, staying the mixture in a mineral-containing container still to release trace mineral elements into the mixture, and killing bacteria in the mixture to form a product.

### BACKGROUND OF THE INVENTION

The present invention relates to a method of preparing bioenergetic nourishing water. More particularly, the present invention relates to a method of preparing bioenergetic nourishing water which will increase a health of a user under such a regimen.

There are many methods to clean water from a water source. A water softening method uses cations in an ion exchange resin to exchange magnesium and calcium in water. However, the water softening method cannot filter impurities in water effectively. An active carbon filtration method uses active carbons to adsorb organic compounds such as trichloromethane and pesticides in order to clean water. However, active carbons cannot remove nitrates, nitrites, and heavy metals effectively. Furthermore, bacteria will be adsorbed on the active carbons to produce biological films. A distillation method cannot remove volatile compounds such as trichloromethane and trifluoromethane from the distilled water. Volatile compounds such as trichloromethane and trifluoromethane will remain in a boiling water also. A reverse osmosis method will produce pure water. However, trace mineral elements cannot remain in the pure water. Trace mineral elements are essential to health.

### SUMMARY OF THE INVENTION

An object of the present invention is to provide a method of preparing bioenergetic nourishing water which will increase a health of a user under such a regimen.

Accordingly, a method of preparing bioenergetic nourishing water comprises steps of filtrating water from a water source to form a filtrated water, adjusting a hardness of the filtrated water, filtrating the filtrated water with ceramics to remove an original memory structure of the filtrated water, adding main herb liquid into the filtrated water to form a mixture, magnetizing the mixture to remove the main herb liquid from the mixture and to input and to arrange a new memory structure of the mixture, staying the mixture in a mineral-containing container still to release trace mineral elements into the mixture, and killing bacteria in the mixture to form a product.

### DETAILED DESCRIPTION OF THE INVENTION

A method of preparing bioenergetic nourishing water comprises steps of:

step A: filtrate water from a water source to form a filtrated water in order to remove impurities and toxic materials in the water source,

step B: adjust a hardness of the filtrated water in order to decrease a degree of calcification and a total solid amount in the filtrated water,

step C: filtrate the filtrated water with ceramics to remove an original memory structure of the filtrated water and to remove alga and fungi in the filtrated water,

step D: add main herb liquid into the filtrated water to form a mixture,

step E: magnetize the mixture to remove the main herb liquid from the mixture and to input and to arrange a new memory structure of the mixture with a frequency resonance method,

step F: stay the mixture in a mineral-containing container still to release trace mineral elements into the mixture, and

step G: kill bacteria in the mixture to form a product.

The trace mineral elements comprise magnesium, iron, zinc, copper, cobalt, chromium, iodine, fluorine, nickel, and selenium. The trace mineral elements will become active centers of hormones, vitamins, and nucleic acids.

The bioenergetic nourishing water will increase a health of a user under such a regimen. The bioenergetic nourishing water has trace mineral elements and maintain a herb effect.

The present invention is not limited to the above embodiment but various modification thereof may be made. Furthermore, various changes in form and detail may be made without departing from the scope of the present invention.

I claim:

1. A method of preparing bioenergetic nourishing water comprises steps of:
filtrating water from a water source to form a filtrated water,
adjusting a hardness of the filtrated water,
filtrating the filtrated water with ceramics to remove an original memory structure of the filtrated water,
adding main herb liquid into the filtrated water to form a mixture,
magnetizing the mixture to remove the main herb liquid from the mixture and to input and to arrange a new memory structure of the mixture,
staying the mixture in a mineral-containing container still to release trace mineral elements into the mixture, and
killing bacteria in the mixture to form a product.
